(19) United States
(12) Patent Application Publication
(10) Pub. No.: US 2016/0380968 A1
(43) Pub. Date: Dec. 29, 2016

(54) GENERATING NETWORK DEVICE NAMES

(71) Applicant: Intel Corporation, Santa Clara, CA (US)

(72) Inventors: Usman Sarwar, Penang (MY); Lee Booi Lim, Batu Maung (MY)

(73) Assignee: Intel Corporation, Santa Clara, CA (US)

(21) Appl. No.: 14/751,319

(22) Filed: Jun. 26, 2015

(51) Int. Cl. H04L 29/12; H04W 88/16

(52) U.S. Cl. CPC H04L 61/30; H04W 88/16

(57) ABSTRACT

A method for naming devices in a network is described herein. The method includes receiving, via a processor, device information associated with a device, a gateway, or both, from the gateway. The method also includes analyzing, via the processor, the device, the gateway, or both, using the device information to generate human-to-machine and machine-to-machine relationship contexts. The method further includes generating, via the processor, classifications for the device, the gateway, or both, based on human-to-machine and machine-to-machine relationship contexts. The method also further includes generating, via the processor, a device name for the device, the gateway, or both, based on the classifications. The method also includes sending, via the processor, the device name or device names to the gateway.

### TECHNICAL FIELD

The present invention relates generally to device representation. More specifically the present invention relates to techniques for naming devices in a network.

### BACKGROUND

Networking protocols are defined for creating separate systems for RFID (radio-frequency identification) and WSN (wireless sensor network) devices. For example, monotonous names for IoT (Internet of Things) devices can be created using identifications in strings via a static approach. Other protocols specific to RFID systems use a URI (Uniform Resource Identifier) based format and create ID base names by providing a type of DNS service for RFIDs.

### BRIEF DESCRIPTION OF THE DRAWINGS

FIG. 1 is a block diagram illustrating an example system that can be used to name devices based on inference;

FIG. 2 is a block diagram of an example system providing for a context-aware naming service;

FIG. 3 is a block diagram of an example system providing a context-aware naming;

FIG. 4 shows a pair of block diagrams of example classifications providing for a context-aware naming;

FIG. 5 is a process flow diagram illustrating an example method that depicts context-aware naming for devices;

FIG. 6 is a process flow diagram illustrating an example method that depicts conflict resolution for conflicting device names;

FIG. 7 is a block diagram illustrating an example computing device that can be used as a node for naming devices; and

FIG. 8 is a block diagram showing computer readable media that store code for naming of devices.

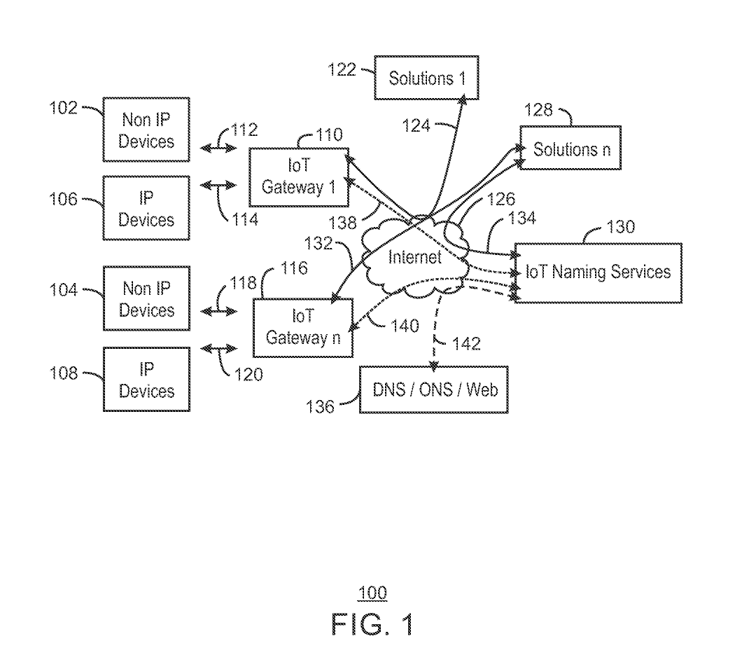

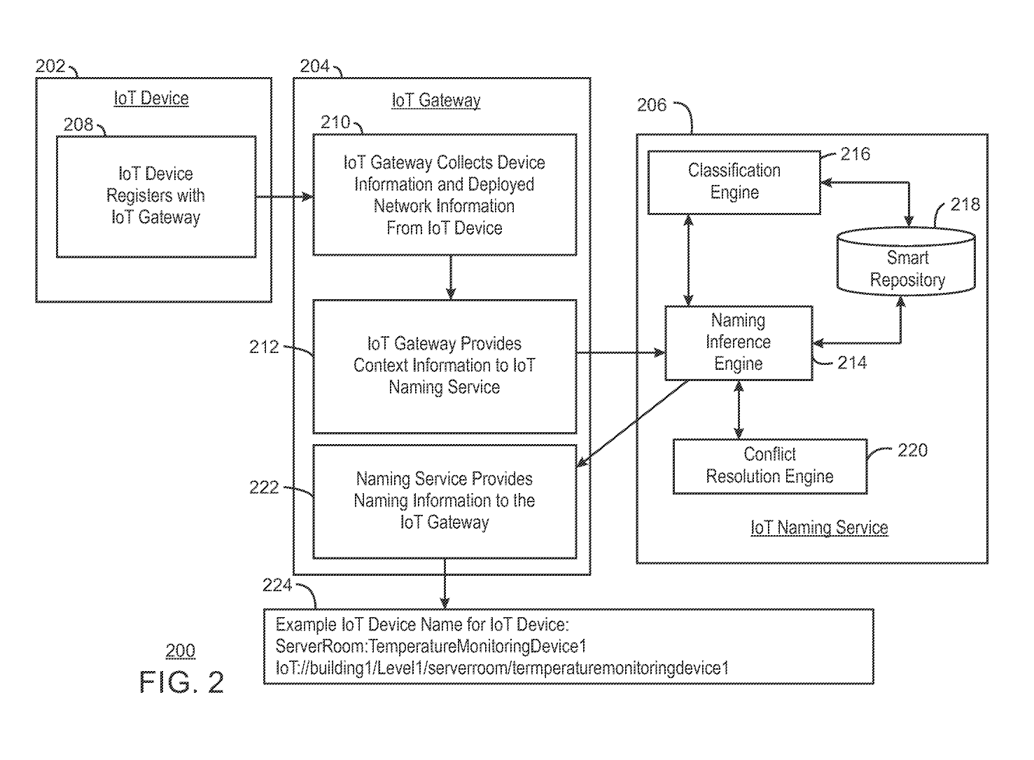

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

In the following description and claims, the term Internet of Things (IoT) refers to an interconnection of uniquely identifiable embedded computing devices within an existing network infrastructure, such as the Internet. Heterogeneous devices refers to devices including IP-based devices and non-IP-based devices such as RFIDs, WSN devices, among others. A parameter, as used herein, refers to input variables, such as device information, device configuration, etc.

Techniques for naming devices in networks based on inference from contextual information are provided herein. One or more devices may register with a gateway. The gateway may provide IoT Naming Service parameters describing the context in which the devices, including the gateway, are operating. For example, an IoT gateway may provide deployment and use case information such as smart home information to an IoT service provider. An IoT Naming Service can be implemented as a local service on an IoT gateway or as a global cloud-based service. The IoT Naming Service can then classify the devices based on the parameters. In some examples, the IoT Naming Service can determine relationships between human-to-machine (H2M) and machine-to-machine (M2M) relationship contexts. The IoT Naming Service can then perform inference to create URI-based device names. Thus, techniques described herein provide a flexible system and method for naming heterogeneous devices in cloud-based networks. Such a system enables users of IoT networks to identify the devices without the resources and time necessary to locate and name the devices manually. Moreover, such names can be interoperable between heterogeneous IoT systems and devices.

Some embodiments may be implemented in one or a combination of hardware, firmware, and software. Some embodiments may also be implemented as instructions stored on a computer readable medium, which may be read and executed by a computing platform to perform the operations described herein. A computer readable medium may include any mechanism for storing or transmitting information in a form readable by a machine, e.g., a computer. For example, a computer readable medium may include read only memory (ROM); random access memory (RAM); magnetic disk storage media; optical storage media; flash memory devices; or the interfaces that transmit and/or receive signals, among others.

An embodiment is an implementation or example. Reference in the specification to “an embodiment”, “one embodiment”, “some embodiments”, “various embodiments”, or “other embodiments” means that a particular feature, structure, or characteristic described in connection with the embodiments is included in at least some embodiments, but not necessarily all embodiments, of the inventions. The various appearances of “an embodiment”, “one embodiment or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram illustrating an example system that can be used to name devices based on inference. In FIG. 1, the example system 100 includes non-Internet-Protocol (IP) devices 102 and 104 and Internet Protocol (IP) devices 106 and 108. The non-IP devices 102 and IP devices 106 are connected to a gateway 110 via connections 112 and 114. The non-IP device 104 and IP devices 108 are connected to a gateway 116 via connections 118 and 120. A solution service 122 is connected to gateway 110 via a connection 124. The connection 124 is one of a plurality of connections over the Internet 126. A solution service 128 is connected to the gateway 116 and a naming service 130 via connections 132 and 134. The naming service 130 is also connected to the gateway 110, the gateway 116, and a server 136 via connections 138, 140, and 142, respectively.

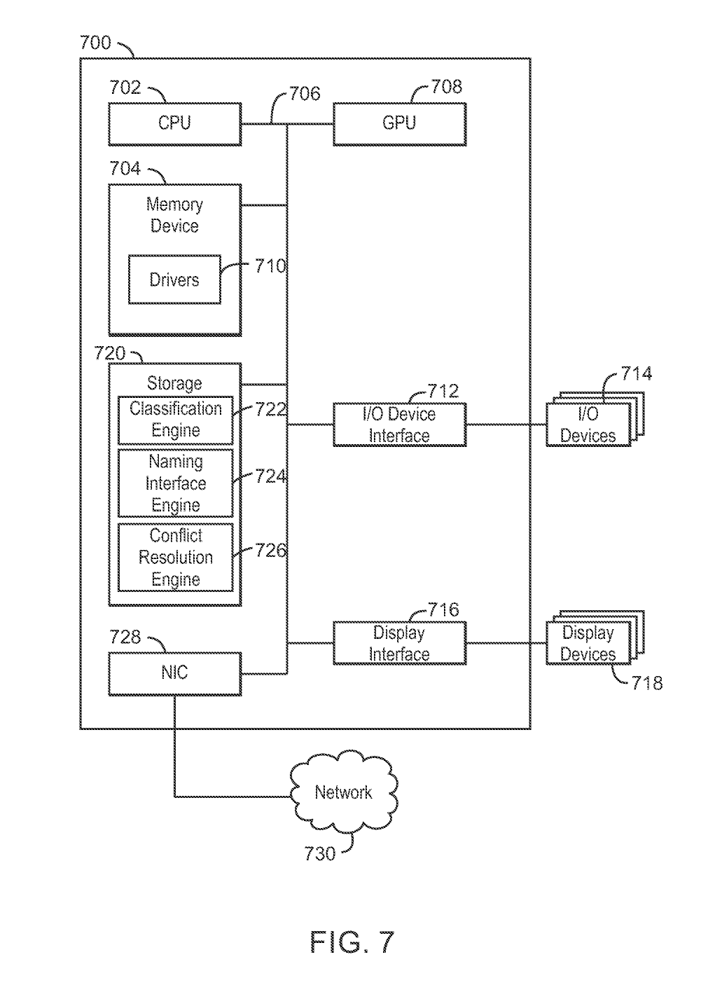

In the example system 100, a plurality of devices 102, 104, 106, 108 can be connected to a network such as the Internet 126 via gateways 110 and 116. The non-IP devices can be devices without an IP address, such as RFIDs, sensors in a WSN, etc. In some examples, the devices 102, 104, 106, 108 can register with one or more of the gateways 110 and 116. The gateways 110 and 116 can receive device information from the device 102, 104, 106, and 108 and provide device information associated with the devices 102, 104, 106, and 108 to the Internet of Things (IoT) Naming Service. For example, the IoT Naming Service can be a cloud-based service implemented on a machine such as the computing device 700 described in FIG. 7 below. The IoT Naming Service can also receive additional device information from one or more servers 136. For example, a server 136 can be a Domain Name System (DNS) server, Object Naming System (ONS) server, or a web server. In some examples, an ONS server can leverage a Domain Name System (DNS) to discover information about a device and related services. The device and service information can be shared with the IoT Naming Service 130 for use with contextual inference-based naming of the devices 102, 104, 106, and 108. In some examples, the IoT Naming Service 130 can also receive device information from solution services 128. For example, solution services 128 can include IoT applications and/or services that managing and/or controlling one or more of the devices 102, 104, 106, and 108 as shown with respect to solution service 122. In addition, when implemented as a distributed computing service, the IoT naming service can be used by any application or service through the Internet. For example, a smart building application or asset tracking and managing system can communicate with the naming service and get the names for associated devices. In some examples, the device information can be provided to the IoT Naming Service 130 in the form of parameters.

The diagram of FIG. 1 is not intended to indicate that the example system 100 is to include all of the components shown in FIG. 1. Rather, the example system 100 can include fewer or additional components not illustrated in FIG. 1 (e.g., additional devices, gateways, solutions, servers, etc.).

FIG. 2 is a block diagram of an example system providing for a context-aware naming service according to the techniques described herein. In FIG. 2, the example system 200 includes a device 202 that is connected to a gateway 204. The gateway is communicatively coupled to a naming service 206. The gateway 204 is shown providing 212 device information to naming inference engine 214 of the naming service 206. The naming service 206 also includes a classification engine 216, a smart repository 218, and conflict resolution engine 220. The naming inference engine is shown providing 222 naming information to the gateway. An example naming information is shown at block 224.

In the example system of FIG. 2, at block 208, the device 202 can register itself with a gateway 204. In some examples, the gateway 204 can discover the device 202 without registration. At block 210, the gateway 204 can then collect device information and deployed network information. For example, the device information can include information such as sensor attributes, device type, among other information. In some examples, the deployed network information can include a list of devices, a routing table, and locations of the devices. The gateway 204 can then create context information from the device information. At block 212, the gateway 204 can provide the context information to the naming inference engine 214. For example, the context information can be sent as a set of parameters.

Still referring to FIG. 2, the naming service 206 can receive the parameters from the gateway 204 and use classification engine 216 with an ontology to classify characteristics of the device 202. The naming inference engine 214 can then create a context-aware name for the device 202. In some example, the context-aware name may conflict with a previously created name that already may exist in the smart repository 218. The conflict resolution engine 220 can be used to eliminate any detected conflicts with earlier created names. For example, upon detecting a name conflict, the conflict resolution engine 220 can receive additional attributes from the classification engine 216 and append the attributes to the conflicting names if they differ. The updated names can then be provided to the gateway 204. In some examples, the updated names can also be saved to the smart repository 218. At block 222, the IoT Naming Service 206 provides naming information to the IoT gateway. For example, the naming information can include one or more device names among other information such as accessibility levels of the device names. For example, a temperature monitoring device in a server room with a proprietary name of ServerRoom:TemperatureMonitoringDevicel can have an IoT device name of IoT://building1/Level1/serverroom/temperaturemonitoringdevice1, wherein the temperature monitoring device is located on a first level of a building 1. In some examples, preexisting systems such as RFID asset management systems can use the naming service to provide easily understandable identification with context information to users. For example, an id of 0xAB1234890 can be changed to NYWarehouse:NZFruitsContainer. In any case, a preexisting system could use existing formats or an IoT name format provided by default with the IoT Naming Service 206. In some examples, a company may have a preexisting name formatting, but use the IoT Naming Service 206 get names for devices.

The diagram of FIG. 2 is not intended to indicate that the example system 200 is to include all of the components shown in FIG. 2. Rather, the example system 200 can include fewer or additional components not illustrated in FIG. 2 (e.g., additional devices, gateways, naming services, etc.).

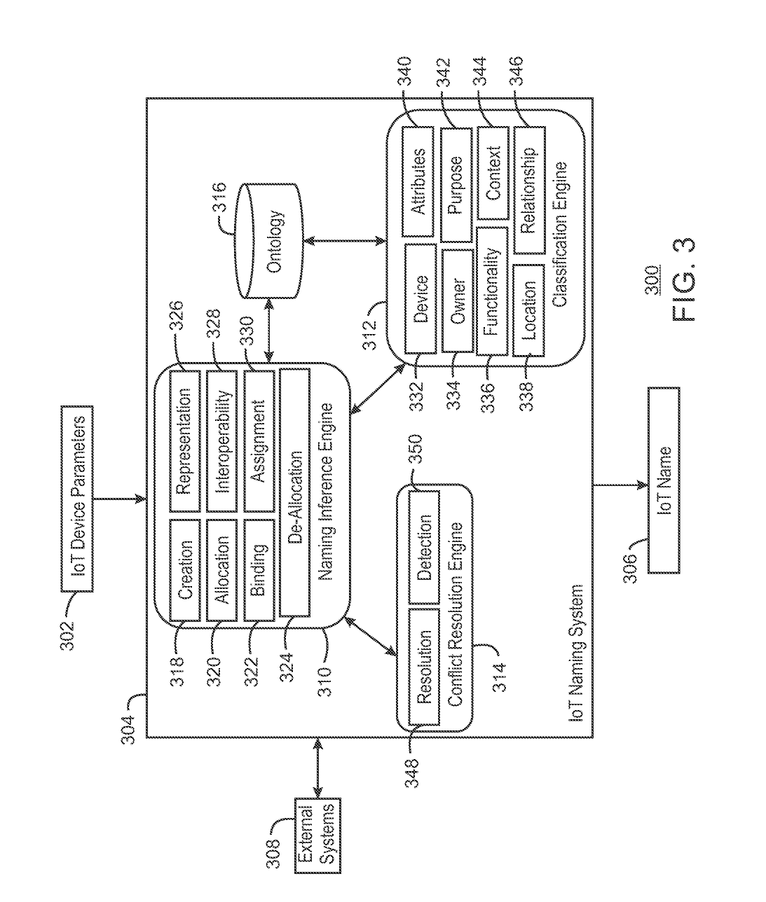

FIG. 3 is a block diagram of an example system providing for a context-aware naming service according to the techniques described herein. The system 300 can be implemented as a service on example computing device 700 of FIG. 7 below or as a local service on a gateway 110, 116 of FIG. 1 above.

In FIG. 3, the example system 300 includes device parameters 302 that are shown being sent to a naming system 304. The naming system 304 is shown outputting a device name 306 and communicatively coupled with external systems 308. For example, external systems 308 may refer to any other system that the IoT naming system interfaces to get information and/or services or provide information and/or services to. The naming system 304 includes a naming inference engine 310 that is coupled to a classification engine 312, a conflict resolution engine 314, and ontology 316. The ontology 316 is also coupled to the classification engine 312. The naming inference engine includes functional blocks representing creation 318, allocation 320, binding 322, de-allocation 324, representation 326, interoperability 328, and assignment 330. The classification engine 312 includes functional blocks representing classes of device information including type of device 332, an owner 334, a functionality 336, a location 338, attributes 340, purpose 342, context 344, and relationship 346. The conflict resolution engine 314 includes blocks representing a resolution component 348 and a detection component 350.

In the example system 300, the context-aware naming system 304 can create context aware and human understandable names for devices. For example, the naming inference engine 310 can receive device information in the form of one or more device parameters 302. The creation component 318 can request the classification engine 312 for creating context aware names for the device. In some examples, the classification engine 312 can also be requested to resolve naming conflicts with the conflict resolution engine 314. The representation component 326 can create device names with different representations. For example, the device name representation can take the form of a Uniform Resource Identifier (URI). The interoperability component 328 can work with the representation component 326 to create interoperable naming representations and annotations for devices. The interoperability component 328 can thus assist the creation of different types of naming representations such as EPCGLOBAL® Object Name Service (ONS) representations. The allocation component 320 and assignment component 330 can allocate and assign resources for the created names by informing the overall use-case application system. The binding component 322 can bind the name with the identification of the device from an overall use-case perspective. For example, a communication binding method can provide binding of naming with the device, group of devices and their services. In some examples, the de-allocation component 324 can safely remove name assignments.

Still referring to FIG. 3, the classification engine 312 can classify device information including the parameters into logical classes. For example, the classes can include type of device 332, attributes 340 of the device, owner 334 of the device and purpose 342 of usage. The classification engine 312 can use an ontology 316 to utilize the context of a device and the use-case scenario by using knowledge-based classification and inference.

In some examples, two device names may conflict. The conflict resolution engine 314 can resolve conflicts as the naming inference engine 310 creates and assigns the names. The detection component 350 of the conflict resolution engine 314 can confirm device name conflicts with the overall naming system 304. The resolution component 348 can resolve the detected conflict by suggesting alternative names. For example, the alternative names can be considered by the naming inference engine 310 as the naming inference engine 310 creates updated names using the knowledge base. The ontology 316 can include multi-domain contexts. For example, the ontology 316 can include relationships between different use-cases and the devices.

The diagram of FIG. 3 is not intended to indicate that the example system 300 is to include all of the components shown in FIG. 3. Rather, the example system 300 can include fewer or additional components not illustrated in FIG. 3 (e.g., additional device parameters, names, engines, etc.).

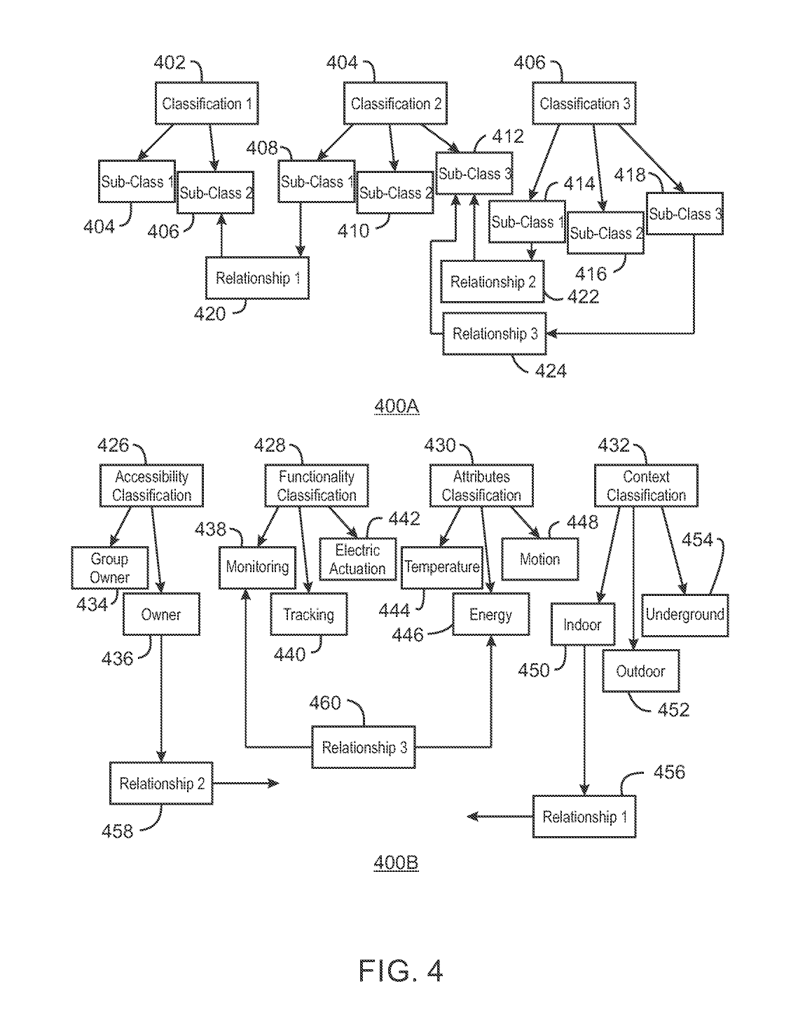

FIG. 4 shows a pair of block diagrams of example classification systems providing for a context-aware naming according to the techniques described herein. The classification systems include classes representing different types of classifications for devices, such as accessibility, functionality, attributes, and context. Each classification is also associated with sub-classes representing particular characteristics within a class. The sub-classes of different classifications can be connected with relationships that represent correlations between different sub-classes. For example, a device having a characteristic represented by one sub-class may be very likely to have a characteristic represented by the other class in the relationship.

In FIG. 4, the example classification system 400A includes classifications 402, 404, and 406. The classification 402 includes sub-classes 404 and 406. The classification 404 includes sub-classes 408, 410, and 412. The classification 406 includes sub-classes 414, 416, 418. Sub-class 408 is shown connected to sub-class 406 via a relationship 420. Sub-class 414 is shown connected to sub-class 412 via a relationship 422. Sub-class 418 is shown connected to sub-class 412 via a relationship 424.

In example classification system 400A, the relationships 420, 422, and 424 can be used to name one or more devices. For example, a device may have a name including sub-class 406 and sub-class 408 based on relationship 420. For example, as discussed in reference to FIG. 400B, a sensor may have a relationship between an energy attribute sub-class and a monitoring functionality sub-class. Thus, the device name may include these two sub-classes to differentiate the device from similar devices. Another device may have a device name including sub-class 412 and sub-classes 414 and 418 based on relationships 422 and 424.

The example classification system 400B includes accessibility classification 426, functionality classification 428, attributes classification 430, and context classification 432. The accessibility classification 426 is connected with a group owner 434 and an owner 436. The functionality classification 428 is connected to a monitoring 438 functionality, a tracking 440 functionality, and an electric actuation 442 functionality. The attributes classification 430 is connected to a temperature 44, an energy 446, and a motion 448. The context classification 432 is connected to an indoor 450 context, an outdoor 452 context, and an underground 454 context.

In the example classification system 400B, the owner sub-class 436 is shown having an open relationship 458 and thus can be appended to any of the other sub-classes. For example, IoT devices can be associated with any owner and multiple owners may exist for physical or virtual devices of the same type. The energy sub-class 446 is shown as having a closed relationship with monitoring 438. For example, energy devices may imply a monitoring functionality. The indoor sub-class 450 is also shown having an open relationship with other sub-classes. For example, the placement of the devices can be anywhere. The device names can thus be used to differentiate between similar devices based on their specific location.

The diagram of FIG. 4 is not intended to indicate that the example classification systems 400A and 400B are to include all of the components shown in FIG. 4. Rather, the example classification systems 400A and/or 400B can include fewer or additional components not illustrated in FIG. 4 (e.g., additional classifications, sub-classes, relationships, etc.).

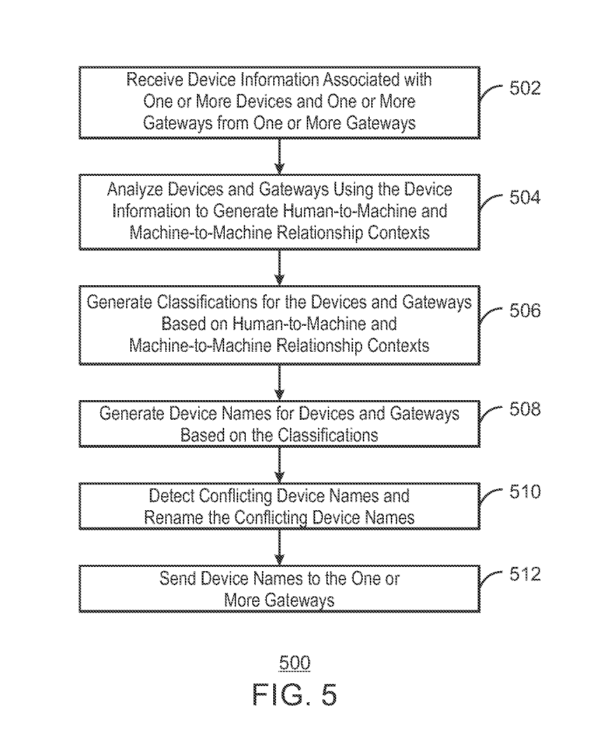

FIG. 5 is a process flow diagram illustrating an example method that depicts context-aware naming for devices. The example method of FIG. 5 is generally referred to by the reference number 500 and is discussed with reference to FIG. 3.

At block 502, device information 302 associated with one or more devices and one or more gateways is received from one or more gateways. For example, one or more devices may have registered with the one or more gateways and provided the gateways with device information. In some examples, the gateways can discover one or more devices and gather device information from the devices. In some examples, the device information can be received from the gateways in the form of parameters.

At block 504, a naming inference engine 310 can analyze the devices and gateways using the device information to generate human-to-machine and machine-to-machine relationship contexts. For example, one or more relationship contexts can be created as discussed in greater detail with respect to FIG. 4 above.

At block 506, the classification engine 312 can generate classifications for the devices and gateways based on human-to-machine and machine-to-machine relationship contexts. For example, human-to-machine relationships can include owners or group owners that are associated with particular devices. Machine-to-machine relationships can describe associations between devices. For example, an energy device may be an end node to a ZIGBEE® personal area network coordinator; thus, the ZIGBEE® coordinator can also be classified as a controller of the end nodes. In another example, a device-to-device relationship can be the relationship between a soil moisture sensor and a sprinkler. In some examples, the classification engine 312 can generate classifications based on a network topology.

At block 508, the naming inference engine 310 can generate device names for devices and gateways based on the classifications. For example, the names may be created using inferences from the relationship contexts. The names can be strings in the form of URIs that include one or more classification attributes. For example, the device names can be Level1ServerRoomGateway, Level1ServerRoomTemperatureSensor, Level1LobbyGateway, for a gateway located in a server room of a first floor, a temperature sensor located in the server room of the first floor, and a gateway located in the lobby of the first floor. In some examples, the names can be generated as small as possible to differentiate the devices while avoiding conflicts between names. In addition, privacy settings can be applied to configure an accessibility level of the names. For example, the accessibility level can be used to limit access to the devices, groups of devices, or services associated with the devices.

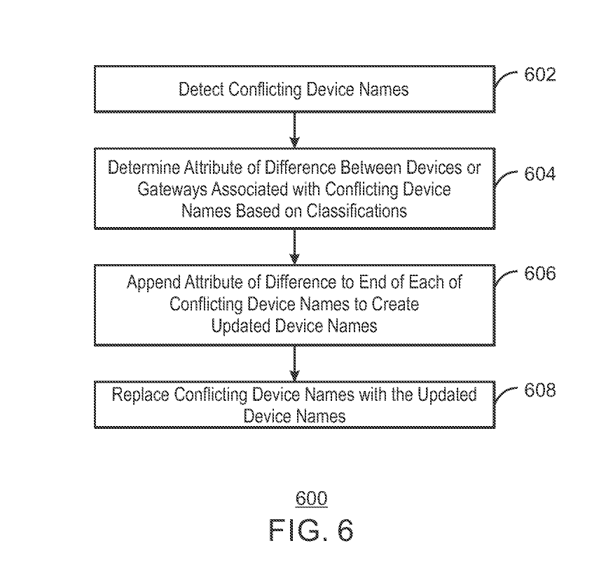

At block 510, the conflict resolution engine 314 can detect conflicting device names and the naming inference engine can rename the conflicting device names. For example, a new device may be very similar to an existing device on the network. If the attributes used to name the existing device are similar to the new device, then an additional attribute can be appended to the device names. Therefore, devices that are more similar may have longer names. In some examples, the additional attribute can be chosen based on an attribute that differs between the two devices. Thus, the additional attribute may be referred to as an attribute of difference. In some examples, attributes that are similar can be replaced with the attributes of difference in order to keep the names smaller in size. An example method for name conflict resolution is discussed at greater length in FIG. 6 below.

At block 512, the naming system 304 sends device names 306 for devices to the one or more gateways. The gateways can then send the device names for the devices to servers or applications for identifying the devices. In some examples, binding can be provided to bind device names with a device, group of devices, and their services. In addition, the naming system can receive device information from and send the device names to a Domain Name System (DNS) server, an Object Naming Service (ONS) server, a web server, or any combination thereof. The naming system can also receive device information from and send the device names to a networking application service. For example, the networking application service can be an Internet of Things (IoT) application, an IoT service, or both.

This process flow diagram is not intended to indicate that the blocks of the method 500 are to be executed in any particular order, or that all of the blocks are to be included in every case. Further, any number of additional blocks not shown may be included within the method 500, depending on the details of the specific implementation.

FIG. 6 is a process flow diagram illustrating an example method that depicts server-side functionality for discovering devices. The example method of FIG. 6 is generally referred to by the reference number 600 and is discussed with reference to FIG. 3.

At block 602, the detection component 350 of the conflict resolution engine 314 can detect conflicting device names. For example, a device with similar properties may have already been assigned the same name as another device in a network or group of devices.

At block 604, the naming inference engine 310 can determine an attribute of difference between devices or gateways associated with conflicting device names based on the classifications from the classification engine 312. In some examples, the devices with conflicting names may have one or more attributes that are different. For example, both devices may be used outside with respect to location 338, but one device may be used for watering plants in terms of purpose 342, while another device may be used to clean a pool.

At block 606, the naming inference engine 310 can append the attribute of difference to an end of each of the conflicting device names to create updated device names. In some examples, shared attributes may be removed from the device names to shorten the updated device names.

At block 608, the naming inference engine 310 replaces the conflicting device names with the updated device names. The updated names can then be assigned to the corresponding devices. In some examples, the replaced conflicting device names can be deallocated by the deallocation component 324 of the naming inference engine 310.

This process flow diagram is not intended to indicate that the blocks of the method 600 are to be executed in any particular order, or that all of the blocks are to be included in every case. Further, any number of additional blocks not shown may be included within the method 600, depending on the details of the specific implementation.

FIG. 7 is a block diagram illustrating an example computing device that can be used as a node for naming devices. The computing device 700 may be, for example, a laptop computer, desktop computer, tablet computer, mobile device, or server, among others. The computing device 700 may include a central processing unit (CPU) 702 that is configured to execute stored instructions, as well as a memory device 704 that stores instructions that are executable by the CPU 702. The CPU 702 may be coupled to the memory device 704 by a bus 706. Additionally, the CPU 702 can be a single core processor, a multi-core processor, a computing cluster, or any number of other configurations. Furthermore, the computing device 700 may include more than one CPU 702. The memory device 704 can include random access memory (RAM), read only memory (ROM), flash memory, or any other suitable memory systems. For example, the memory device 704 may include dynamic random access memory (DRAM).

The computing device 700 may also include a graphics processing unit (GPU) 708. As shown, the CPU 702 may be coupled through the bus 706 to the GPU 708. The GPU 708 may be configured to perform any number of graphics operations within the computing device 700. For example, the GPU 708 may be configured to render or manipulate graphics images, graphics frames, videos, or the like, to be displayed to a user of the computing device 700.

The memory device 704 can include random access memory (RAM), read only memory (ROM), flash memory, or any other suitable memory systems. For example, the memory device 704 may include dynamic random access memory (DRAM). The memory device 704 may include device drivers 710 that are configured to execute the instructions for device discovery. The device drivers 710 may be software, an application program, application code, or the like.

The CPU 702 may also be connected through the bus 706 to an input/output (I/O) device interface 712 configured to connect the computing device 700 to one or more I/O devices 714. The I/O devices 714 may include, for example, a keyboard and a pointing device, wherein the pointing device may include a touchpad or a touchscreen, among others. The I/O devices 714 may be built-in components of the computing device 700, or may be devices that are externally connected to the computing device 700. In some examples, the memory 704 may be communicatively coupled to I/O devices 714 through direct memory access (DMA).

The CPU 702 may also be linked through the bus 706 to a display interface 716 configured to connect the computing device 700 to a display device 718. The display device 718 may include a display screen that is a built-in component of the computing device 700. The display device 718 may also include a computer monitor, television, or projector, among others, that is internal to or externally connected to the computing device 700.

The computing device also includes a storage device 720. The storage device 720 is a physical memory such as a hard drive, an optical drive, a thumbdrive, an array of drives, or any combinations thereof. The storage device 720 may also include remote storage drives. The storage device 720 includes a classification engine 722, a naming inference engine 724, and conflict resolution engine 726. The classification engine 722 can receive device information from one or more gateways. For example, the device information can be in the form of a set of parameters that describe device context information. The classification engine 722 can analyze devices and gateways using the device information to generate human-to-machine and machine-to-machine relationship contexts. For example, the classification engine can receive deployed network information from the gateway and analyze the device and gateway based on the deployed network information. The devices can be a plurality of heterogeneous device in a network. In some examples, the classification engine 722 can classify the devices and gateways based on human-to-machine and machine-to-machine relationship contexts to generate classifications. The naming inference engine 724 can be used to create names for the devices and gateways based on the classifications. For example the naming inference engine 724 can perform inference based on the classifications. The inference engine 724 can perform inference based on use cases and can determine how the classifications are connected logically and/or semantically to create the device names as explained in greater detail with regard to FIG. 4 above. For example, an outdoor device that functions to monitor temperature can be named “OutdoorTemperatureMonitoringDevice.” A conflict resolution engine 726 can detect conflicting device names and the naming inference engine 724 can rename the conflicting device names. For example, the conflict resolution engine 726 can suggest alternate devices names to the naming inference engine 724. In some examples, the naming inference engine 724 can determine an attribute of difference between devices associated with the conflicting device names based on the classifications. The naming inference engine 724 can also append an attribute of difference to an end of each of the conflicting device names to create updated device names. The naming inference engine 724 can then replace the conflicting device names with the updated device names. The naming inference engine 724 can also be configured to send the device names to the one or more gateways. In some examples, the classification engine can receive device information from and send the device name to a Domain Name System (DNS) server, an Object Naming Service (ONS) server, a web server, or any combination thereof. In some examples, the classification engine can receive device information from and send the device name to an Internet of Things (IoT) application, an IoT service, or both. In some examples, the device name is interoperable with any of a plurality of heterogeneous devices.

In some examples, the naming inference engine can configure an accessibility level for the device, a group of devices including the device, a service associated with the device, or any combination thereof. In some examples, the accessibility level can be associated with a gateway, group of devices associated with the gateway, a service associated with the gateway, or any combination thereof.

The computing device 700 may also include a network interface controller (NIC) 728. The NIC 728 may be configured to connect the computing device 700 through the bus 706 to a network 730. The network 730 may be a wide area network (WAN), local area network (LAN), or the Internet, among others. In some examples, the device may communicate with other devices through a wireless technology. For example, Bluetooth® or similar technology may be used to connect with other devices.

The block diagram of FIG. 7 is not intended to indicate that the computing device 700 is to include all of the components shown in FIG. 7. Rather, the computing system 700 can include fewer or additional components not illustrated in FIG. 7, such as additional engines, additional network interfaces, and the like. The computing device 700 may include any number of additional components not shown in FIG. 7, depending on the details of the specific implementation. Furthermore, any of the functionalities of the CPU 702 may be partially, or entirely, implemented in hardware and/or in a processor. For example, the functionality of the classification engine 722, the naming inference engine 724, and the conflict resolution engine 726 may be implemented with an application specific integrated circuit, in logic implemented in a processor, in logic implemented in a specialized graphics processing unit, or in any other device.

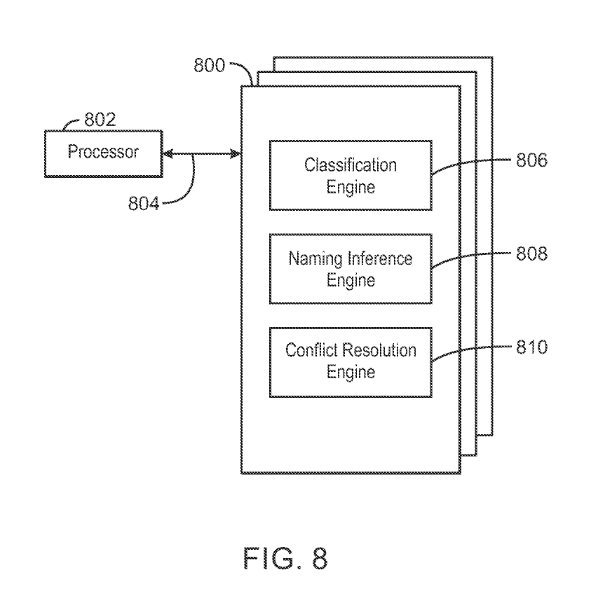

FIG. 8 is a block diagram showing computer readable media 800 that store code for naming of devices. The computer readable media 800 may be accessed by a processor 802 over a computer bus 804. Furthermore, the computer readable medium 800 may include code configured to direct the processor 802 to perform the methods described herein. In some embodiments, the computer readable media 800 may be non-transitory computer readable media. In some examples, the computer readable media 800 may be storage media. However, in any case, the computer readable media do not include transitory media such as carrier waves, signals, and the like.

The block diagram of FIG. 8 is not intended to indicate that the computer readable media 800 is to include all of the components shown in FIG. 8. Further, the computer readable media 800 may include any number of additional components not shown in FIG. 8, depending on the details of the specific implementation.

The various software components discussed herein may be stored on one or more computer readable media 800, as indicated in FIG. 8. For example, a classification engine 806 may be configured to receive device information from one or more gateways. For example, the device information may include one or more parameters associated with one or more devices and/or gateways. For example, the devices may be a plurality of heterogeneous devices in a network. In some examples, the classification engine 806 may analyze the devices and/or gateways using the device information to generate human-to-machine and machine-to-machine relationship contexts. The classification engine 806 may classify the devices and/or gateways based on human-to-machine and machine-to-machine relationship contexts. A naming inference engine 808 may be configured to create device names for devices and/or gateways based on the classifications. For example the naming inference engine 808 can perform inference based on the classifications. The inference engine 808 can perform inference based on use cases and can determine how the classifications are connected logically and/or semantically to create the device names as explained in greater detail with regard to FIG. 4 above. A conflict resolution engine 810 may be configured to detect conflicting device names and rename the conflicting device names. The naming inference engine 808 can also be configured to send the device names to the one or more gateways. In some examples, the device names may be names for the one or more gateways. In any case, the device names can be interoperable with any of the plurality of heterogeneous devices.

In some examples, the naming inference engine 808 may initially give a device a name that conflicts with a previously assigned name. A conflict resolution engine 810 can detect conflicting device names. The naming inference engine 808 can then rename the conflicting device names. For example, the naming inference engine 808 can also include instructions to determine attribute of difference between devices or gateways associated with the conflicting device names based on the classifications. In some examples, the naming inference engine 808 can append an attribute of difference to end of each conflicting device name to create updated device names. The naming inference engine 808 can also include instructions to replace conflicting device names with the updated device names.

Still referring to FIG. 8, in some examples, the naming inference engine 808 can also configure an accessibility level for the device, a group of devices including the device, a service associated with the device, or any combination thereof. In some examples classification engine 806 may be configured to receive device information from and send the device name to a Domain Name System (DNS) server, an Object Naming Service (ONS) server, a web server, or any combination thereof. In some examples, the classification engine 806 may be configured to receive device information from and send the device name to a networking application service. For example, the classification engine 806 may be configured to receive device information from and send device names to an Internet of Things (IoT) application and/or an IoT service. In some examples, the naming inference engine can bind the device name with a network associated with the device or the gateway, a group of devices associated with the device or the gateway, a service associated with the device or the gateway, or any combination thereof.

In some examples, the naming inference engine 808 can also deallocate a device name from a device or gateway. For example, the naming inference engine 808 can deallocate the device name when a device does not need the device name, such as when the device is disposed or moved to another plan. In some examples, the naming inference engine 808 can deallocate the device name when the device name is to be used for some other purpose.

The block diagram of FIG. 8 is not intended to indicate that the computer readable media 800 is to include all of the components shown in FIG. 8. Further, the computer readable media 800 may include any number of additional components not shown in FIG. 8, depending on the details of the specific implementation.

Example 1 is a system for naming devices. The system may include a classification engine to receive device information from a gateway, analyze the device information to generate human-to-machine and machine-to-machine relationship contexts, and classify devices and the gateway based on human-to-machine and machine-to-machine relationship contexts to generate classifications. The system may also include a naming inference engine to create a device name for a device, the gateway, or both, based on the classifications. The naming inference engine may also send the device names to the gateway.

Example 2 includes the system of example 1. This example includes a conflict resolution engine to detect conflicting device names. The naming inference engine may also rename the conflicting device names.

Example 3 includes the system of any combination of examples 1-2. In this example, to rename the conflicting device names, the naming inference engine may determine an attribute of difference between devices associated with the conflicting device names based on the classifications, append an attribute of difference to an end of each of the conflicting device names to create updated device names, and replace the conflicting device names with the updated device names.

Example 4 includes the system of any combination of examples 1-3. In this example, the naming inference engine may configure an accessibility level for the device, a group of devices including the device, a service associated with the device, or any combination thereof.

Example 5 includes the system of any combination of examples 1-4. In this example, the classification engine may receive deployed network information from the gateway and analyze the device, the gateway, or both, based on the deployed network information.

Example 6 includes the system of any combination of examples 1-5. In this example, the device information includes a set of parameters that describe device context information.

Example 7 includes the system of any combination of examples 1-6. In this example, the classification engine may further receive device information from and send the device name to a Domain Name System (DNS) server, an Object Naming Service (ONS) server, a web server, or any combination thereof.

Example 8 includes the system of any combination of examples 1-7. In this example, the classification engine may further receive device information from and send the device name to an Internet of Things (IoT) application, an IoT service, or both.

Example 9 includes the system of any combination of examples 1-8. In this example, the naming inference engine may further perform inference based on the classifications.

Example 10 includes the system of any combination of examples 1-9. In this example, the device may be one of a plurality of heterogeneous devices in a network. The device name may also be interoperable with any of the plurality of heterogeneous devices.

Example 11 is a method for naming of devices. The method may include receiving, via a processor, device information associated with a device, a gateway, or both, from the gateway. The method may also include analyzing, via the processor, the device, the gateway, or both, using the device information to generate human-to-machine and machine-to-machine relationship contexts. The method may further include generating, via the processor, classifications for the device, the gateway, or both, based on human-to-machine and machine-to-machine relationship contexts. The method may also further include generating, via the processor, a device name for the device, the gateway, or both, based on the classifications. The method may also include sending, via the processor, the device name or device names to the gateway.

Example 12 includes the method of example 11. This example includes detecting conflicting device names and renaming the conflicting device names.

Example 13 includes the method of any combination of examples 11-12. In this example, renaming the conflicting device names may include determining an attribute of difference between devices associated with the conflicting device names based on the classifications, appending the attribute of difference to an end of each of the conflicting device names to create updated device names, and replacing the conflicting device names with the updated device names.

Example 14 includes the method of any combination of examples 11-13. This example includes configuring an accessibility level for the device, a group of devices including the device, a service associated with the device, or any combination thereof.

Example 15 includes the method of any combination of examples 11-14. This example includes receiving deployed network information from the gateway and analyzing the device using the deployed network information.

Example 16 includes the method of any combination of examples 11-15. This example includes receiving device information from and sending the device name to a Domain Name System (DNS) server, an Object Naming Service (ONS) server, a web server, or any combination thereof.

Example 17 includes the method of any combination of examples 11-16. This example includes receiving device information from and sending the device name to a networking application service.

Example 18 includes the method of any combination of examples 11-17. This example includes binding the device name with a network associated with the device or the gateway, a group of devices associated with the device or the gateway, a service associated with the device or the gateway, or any combination thereof.

Example 19 includes the method of any combination of examples 11-18. In this example, creating the device name for the device based on the classifications further may include performing inference based on the classifications.

Example 20 includes the method of any combination of examples 11-19. This example includes deallocating a device name from the device or the gateway.

Example 21 includes at least one computer readable medium for naming networked devices having instructions stored therein that, in response to being executed on a computing device, cause the computing device to receive device information from a gateway. The instructions may also cause the computing device to analyze a device, a gateway, or both, using the device information to generate human-to-machine and machine-to-machine relationship contexts. The instructions may also cause the computing device to classify the device, the gateway, or both, based on human-to-machine and machine-to-machine relationship contexts to generate classifications. The instructions may also cause the computing device to create a device name for the device, the gateway, or both, based on the classifications. The instructions may also cause the computing device to detect conflicting device names and rename the conflicting device names. The instructions may also further cause the computing device to send the device names to the gateway.

Example 22 includes the at least one computer readable medium of example 21, further including instructions to determine an attribute of difference between devices or gateways associated with the conflicting device names based on the classifications. The instructions may also cause the computing device to append the attribute of difference to an end of each of the conflicting device names to create updated device names. The instructions may also further cause the computing device to replace the conflicting device names with the updated device names.

Example 23 includes the at least one computer readable medium of any combination of examples 21-22, further including instructions to configure an accessibility level for the device, a group of devices including the device, a service associated with the device, or any combination thereof.

Example 24 includes the at least one computer readable medium of any combination of examples 21-23, further including instructions to receive device information from and send the device name to a Domain Name System (DNS) server, an Object Naming Service (ONS) server, a web server, or any combination thereof.

Example 25 includes the at least one computer readable medium of any combination of examples 21-24, further including instructions to receive device information from and send the device name to a networking application service.

Example 26 includes the at least one computer readable medium of any combination of examples 21-25, further including instructions to receive deployed network information from the gateway and analyze the device, the gateway, or both, based on the deployed network information.

Example 27 includes the at least one computer readable medium of any combination of examples 21-26, further including instructions to receive device information from and send the device name to an Internet of Things (IoT) application, an IoT service, or both.

Example 28 includes the at least one computer readable medium of any combination of examples 21-27, further including instructions to perform inference based on the classifications.

Example 29 includes the at least one computer readable medium of any combination of examples 21-28, further including instructions to deallocate a device name from the device, the gateway, or both.

Example 30 includes the at least one computer readable medium of any combination of examples 21-29, further including instructions to bind the device name with a network associated with the device or the gateway, a group of devices associated with the device or the gateway, a service associated with the device or the gateway, or any combination thereof.

Example 31 is an apparatus for naming of devices. The apparatus may include means for receiving device information associated with a device, a gateway, or both, from the gateway. The example apparatus may include means for analyzing the device, the gateway, or both, using the device information to generate human-to-machine and machine-to-machine relationship contexts. The example apparatus may include means for generating classifications for the device, the gateway, or both, based on human-to-machine and machine-to-machine relationship contexts. The example apparatus may include means for generating a device name for the device, the gateway, or both, based on the classifications. The example apparatus may include means for sending the device name or device names to the gateway.

Example 32 includes the apparatus of example 31. This example includes means for detecting conflicting device names and renaming the conflicting device names.

Example 33 includes the apparatus of any combination of examples 31-32. This example includes means for determining an attribute of difference between devices associated with the conflicting device names based on the classifications. The example apparatus may include means for appending the attribute of difference to an end of each of the conflicting device names to create updated device names. The example apparatus may include means for replacing the conflicting device names with the updated device names.

Example 34 includes the apparatus of any combination of examples 31-33. This example includes means for configuring an accessibility level for the device, a group of devices including the device, a service associated with the device, or any combination thereof.

Example 35 includes the apparatus of any combination of examples 31-34. This example includes means for receiving deployed network information from the gateway and analyzing the device using the deployed network information.

Example 36 includes the apparatus of any combination of examples 31-35. This example includes means for receiving device information from and sending the device name to a Domain Name System (DNS) server, an Object Naming Service (ONS) server, a web server, or any combination thereof.

Example 37 includes the apparatus of any combination of examples 31-36. This example includes means for receiving device information from and sending the device name to a networking application service.

Example 38 includes the apparatus of any combination of examples 31-37. This example includes means for binding the device name with a network associated with the device or the gateway, a group of devices associated with the device or the gateway, a service associated with the device or the gateway, or any combination thereof.

Example 39 includes the apparatus of any combination of examples 31-38. This example includes means for performing inference based on the classifications.

Example 40 includes the apparatus of any combination of examples 31-39. This example includes means for deallocating a device name from the device or the gateway.

Example 41 is an apparatus for naming devices that may include a classification engine configured to receive device information from a gateway. The classification engine may also be configured to analyze the device information to generate human-to-machine and machine-to-machine relationship contexts. The classification engine may also be configured to classify devices and the gateway based on human-to-machine and machine-to-machine relationship contexts to generate classifications. The example apparatus may also include a naming inference engine configured to create a device name for a device, the gateway, or both, based on the classifications. The naming inference engine may also send the device names to the gateway.

Example 42 includes the apparatus of example 41. This example includes a conflict resolution engine configured to detect conflicting device names. The naming inference engine may also rename the conflicting device names.

Example 43 includes the apparatus of any combination of examples 41-42. In this example, to rename the conflicting device names, the naming inference engine may be further configured to determine an attribute of difference between devices associated with the conflicting device names based on the classifications. The naming inference engine may also further be configured to append an attribute of difference to an end of each of the conflicting device names to create updated device names. The naming inference engine may also further be configured to replace the conflicting device names with the updated device names.

Example 44 includes the apparatus of any combination of examples 41-43, the naming inference engine to configure an accessibility level for the device, a group of devices including the device, a service associated with the device, or any combination thereof.

Example 45 includes the apparatus of any combination of examples 41-44, the classification engine further configured to receive deployed network information from the gateway and analyze the device, the gateway, or both, based on the deployed network information.

Example 46 includes the apparatus of any combination of examples 41-45, the device information including a set of parameters that describe device context information.

Example 47 includes the apparatus of any combination of examples 41-46, the classification engine further configured to receive device information from and send the device name to a Domain Name System (DNS) server, an Object Naming Service (ONS) server, a web server, or any combination thereof.

Example 48 includes the apparatus of any combination of examples 41-47, the classification engine further configured to further receive device information from and send the device name to an Internet of Things (IoT) application, an IoT service, or both.

Example 49 includes the apparatus of any combination of examples 41-48, the naming inference engine further configured to perform inference based on the classifications.

Example 50 includes the apparatus of any combination of examples 41-49, the device may be one of a plurality of heterogeneous devices in a network. The device name may also be interoperable with any of the plurality of heterogeneous devices.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A system for naming devices, comprising:
a classification engine to:
receive device information from a gateway;
analyze the device information to generate human-to-machine and machine-to-machine relationship contexts; and
classify devices and the gateway based on human-to-machine and machine-to-machine relationship contexts to generate classifications; and
a naming inference engine to:
create a device name for a device, the gateway, or both, based on the classifications; and
send the device names to the gateway.

2. The system of claim 1, further comprising a conflict resolution engine to detect conflicting device names, wherein the naming inference engine is to rename the conflicting device names.

3. The system of claim 2, wherein to rename the conflicting device names the naming inference engine is to:
determine an attribute of difference between devices associated with the conflicting device names based on the classifications;
append an attribute of difference to an end of each of the conflicting device names to create updated device names; and
replace the conflicting device names with the updated device names.

4. The system of claim 1, the naming inference engine to configure an accessibility level for the device, a group of devices including the device, a service associated with the device, or any combination thereof.

5. The system of claim 1, the classification engine to receive deployed network information from the gateway and analyze the device, the gateway, or both, based on the deployed network information.

6. The system of claim 1, the device information comprising a set of parameters that describe device context information.

7. The system of claim 1, the classification engine to further receive device information from and send the device name to a Domain Name System (DNS) server, an Object Naming Service (ONS) server, a web server, or any combination thereof.

8. The system of claim 1, the classification engine to further receive device information from and send the device name to an Internet of Things (IoT) application, an IoT service, or both.

9. The system of claim 1, the naming inference engine to further perform inference based on the classifications.

10. The system of claim 1, the device comprising one of a plurality of heterogeneous devices in a network, the device name to be interoperable with any of the plurality of heterogeneous devices.

11. A method for naming of devices, comprising:
receiving, via a processor, device information associated with a device, a gateway, or both, from the gateway;
analyzing, via the processor, the device, the gateway, or both, using the device information to generate human-to-machine and machine-to-machine relationship contexts;
generating, via the processor, classifications for the device, the gateway, or both, based on human-to-machine and machine-to-machine relationship contexts;
generating, via the processor, a device name for the device, the gateway, or both, based on the classifications; and
sending, via the processor, the device name or device names to the gateway.

12. The method of claim 11, further comprising detecting conflicting device names and renaming the conflicting device names.

13. The method of claim 12, wherein renaming the conflicting device names comprises:
determining an attribute of difference between devices associated with the conflicting device names based on the classifications;
appending the attribute of difference to an end of each of the conflicting device names to create updated device names; and
replacing the conflicting device names with the updated device names.

14. The method of claim 11, further comprising configuring an accessibility level for the device, a group of devices including the device, a service associated with the device, or any combination thereof.

15. The method of claim 11, further comprising receiving deployed network information from the gateway and analyzing the device using the deployed network information.

16. The method of claim 11, further comprising receiving device information from and sending the device name to a Domain Name System (DNS) server, an Object Naming Service (ONS) server, a web server, or any combination thereof.

17. The method of claim 11, further comprising receiving device information from and sending the device name to a networking application service.

18. The method of claim 11, further comprising binding the device name with a network associated with the device or the gateway, a group of devices associated with the device or the gateway, a service associated with the device or the gateway, or any combination thereof.

19. The method of claim 11, wherein creating the device name for the device based on the classifications further comprises performing inference based on the classifications.

20. The method of claim 11, further comprising deallocating a device name from the device or the gateway.

21. At least one computer readable medium for naming networked devices having instructions stored therein that, in response to being executed on a computing device, cause the computing device to:
receive device information from a gateway;
analyze a device, a gateway, or both, using the device information to generate human-to-machine and machine-to-machine relationship contexts;
classify the device, the gateway, or both, based on human-to-machine and machine-to-machine relationship contexts to generate classifications;
create a device name for the device, the gateway, or both, based on the classifications;
detect conflicting device names and rename the conflicting device names; and
send the device names to the gateway.

22. The at least one computer readable medium of claim 21, comprising instructions to:
determine an attribute of difference between devices or gateways associated with the conflicting device names based on the classifications;
append the attribute of difference to an end of each of the conflicting device names to create updated device names; and
replace the conflicting device names with the updated device names.

23. The at least one computer readable medium of claim 21, comprising instructions to configure an accessibility level for the device, a group of devices including the device, a service associated with the device, or any combination thereof.

24. The at least one computer readable medium of claim 21, comprising instructions to receive device information from and send the device name to a Domain Name System (DNS) server, an Object Naming Service (ONS) server, a web server, or any combination thereof.

25. The at least one computer readable medium of claim 21, comprising instructions to receive device information from and send the device name to a networking application service.
